(19) United States
(12) Patent Application Publication
(10) Pub. No.: US 2017/0125016 A1
(43) Pub. Date: May 4, 2017

(54) METHOD AND ELECTRONIC DEVICE FOR PROCESSING VOICE MESSAGES

(71) Applicants: Le Holdings (Beijing) Co., Ltd., Beijing (CN); Le Shi Zhi Xin Electronic Technology (Tian Jin) Limited, Beijing (CN)

(72) Inventor: Rui WANG, Beijing (CN)

(21) Appl. No.: 15/247,551

(22) Filed: Aug. 25, 2016

Related U.S. Application Data
(63) Continuation of application No. PCT/CN2016/082630, filed on May 19, 2016.

(30) Foreign Application Priority Data
Nov. 2, 2015 (CN) 201510740613.3

(51) Int. Cl. G10L 15/22; G10L 15/02

(52) U.S. Cl. CPC G10L 15/22; G10L 15/02; G10L 2015/223; G10L 2015/221

(57) ABSTRACT

Some embodiments of the present disclosure provide a method and a device for processing voice messages, wherein the method includes: collecting voice data, recognizing and acquiring a voice instruction in the voice data by a first application; outputting a first control and a first prompt message corresponding to the voice instruction, the first prompt message being configured to prompt a performing operation corresponding to the voice instruction to a user; and when an operation on the first control is detected within a first predetermined time, cancelling the voice instruction; otherwise, responding to the voice instruction. Some embodiments of the present disclosure reduce the operation cost and improve the operation efficiency.

### CROSS REFERENCE TO RELATED APPLICATIONS

This application is a continuation of PCT application No. PCT/CN2016/082630, filed May 19, 2016, which is based upon and claims priority to Chinese Patent Application No. 201510740613.3, filed Nov. 2, 2015, the entire contents of which are incorporated herein by reference.

### TECHNICAL FIELD

The disclosure relates to the field of voice recognition technologies, and more particularly, to a method and a device for processing voice messages.

### BACKGROUND

A voice assistant is an application applied to an electronic apparatus, which may implement or substitute partial query or operation of people on the electronic apparatus through voice interaction. The convenience of operating the electronic apparatus in different application scenarios may be improved through this kind of application.

In the prior art, a manner for processing voice messages based on the voice assistant is usually as follows: collecting voice data; recognizing the voice data and recognizing a voice instruction; and performing relevant operations in response to the voice instruction.

The inventors have identified during making of the invention that the manner of processing voice messages in the prior art will respond to the voice instruction after the voice instruction is recognized. However, due to such objective reasons like different recognition precisions or error of voice data entered, the recognized voice instruction may possibly be incorrect; if the voice instruction is wrong, a user can only trigger to end this operation after performing the relevant operation in response to the voice instruction; or passively accept the relevant operation that corresponds to the wrong instruction, resulting in poor user experience, and reducing the operation efficiency and increasing the operation cost.

### SUMMARY

Some embodiments of the present disclosure provide a method and a device for processing voice messages, for solving the technical problem of low operation efficiency in the prior art.

Some embodiments of the present disclosure provide a method for processing voice messages, including:

collecting voice data, recognizing and acquiring a voice instruction in the voice data by a first application;

outputting a first control and a first prompt message corresponding to the voice instruction, the first prompt message being configured to prompt a performing operation corresponding to the voice instruction to a user; and

when an operation on the first control is detected within a first predetermined time, cancelling the voice instruction; otherwise, responding to the voice instruction.

Some embodiments of the present disclosure provide an electronic device for processing voice messages, including:

at least one processor; and

a memory communicably connected with the at least one processor for storing instructions executable by the at least one processor, wherein execution of the instructions by the at least one processor causes the at least one processor to:

collect voice data, recognize and acquire a voice instruction in the voice data;

output a first control and a first prompt message corresponding to the voice instruction, the first prompt message being configured to prompt an performing operation corresponding to the voice instruction to a user; and

when an operation on the first control is detected within a first predetermined time, cancel the voice instruction; otherwise, respond to the voice instruction.

According to the method and device for processing voice messages provided by some embodiments of the present disclosure, the first prompt message and the first control are outputted firstly after collecting the voice data and recognizing the voice instruction, then the voice instruction is responded to after the first predetermined time; if the operation on the first control is detected within the first predetermined time, then the voice instruction may be cancelled and no response is conducted. Therefore, the voice instruction may be cancelled before responding to the voice instruction, i.e., the performing operation corresponding to the voice instruction does not need to be performed, so that the operation cost may be reduced, and the operation efficiency may be improved.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of one embodiment of a method for processing voice messages in accordance with some embodiments;

FIG. 2 is a flow chart of another embodiment of the method for processing voice messages in accordance with some embodiments;

FIG. 3 is a flow chart of another embodiment of the method for processing voice messages in accordance with some embodiments;

FIG. 4 is a schematic diagram of a display interface of a first application during practical application in accordance with some embodiments;

FIG. 5 is a schematic diagram of another display interface of the first application during practical application in accordance with some embodiments;

FIG. 6 is a schematic diagram of another display interface of the first application during practical application in accordance with some embodiments;

FIG. 7 is a schematic diagram of another display interface of the first application during practical application in accordance with some embodiments;

FIG. 8 is a schematic diagram of another display interface of the first application during practical application in accordance with some embodiments;

FIG. 9 is a schematic diagram of a display interface of a second application during practical application in accordance with some embodiments;

FIG. 10 is a structural schematic diagram of one embodiment of a device for processing voice messages in accordance with some embodiments; and

FIG. 11 is a block diagram of an electronic device in accordance with some embodiments.

### DETAILED DESCRIPTION

To make the objects, technical solutions and advantages of some embodiments of the present disclosure more clearly, the technical solutions of the present disclosure will be clearly and completely described hereinafter with reference to some embodiments and drawings of the present disclosure. Apparently, some embodiments described are merely partial embodiments of the present disclosure, rather than all embodiments. Other embodiments derived by those having ordinary skills in the art on the basis of some embodiments of the disclosure without going through creative efforts shall all fall within the protection scope of the present disclosure.

The technical solutions of some embodiments of the present disclosure are mainly applied to an electronic apparatus such as a mobile phone, a tablet, or the like, and application scenarios that operate using a voice recognition technology. Particular to an application like a voice assistant, the operation of the electronic apparatus may be automatically implemented through collecting and recognizing voice data recorded by a user, so as to substitute the operation of the user. In this way, when the user is not convenient to operate the electronic apparatus, for instance, in a scenario of driving a car, or the like, the technical solutions have extremely high use values, and greatly improve the user experience.

As described in the background, reasons like different voice recognition precisions or error of voice data entered will cause error of the voice instruction; or in the case that the user wants to cancel this operation after voice recording, adopting the solution of the prior art can only manually end an performing operation after triggering the performing operation in response to the voice instruction.

For instance, in a scenario of dialing through a voice assistant, a recognized voice instruction is “call XX”, a dialing program will be invoked in response to the voice instruction, the communication number of “XX” will be looked up in a contact list, and a voice connection request for the communication number of “XX” will be initiated in a dialing interface; if the voice instruction is incorrect, the user can only end the voice connection request in the dialing interface of the dialing program, and then restart the voice assistant, and then perform such operations as voice recording, or the like, so as to acquire an accurate voice instruction, which will reduce the operation efficiency and increase the operation cost.

In order to solve the technical problem in the prior art, the inventor provides the technical solutions of some embodiments of the present disclosure through a series of studies. In some embodiments of the present disclosure, after voice data is collected by a first application, and a voice instruction in the voice data is recognized, a first control and a first prompt message corresponding to the voice instruction are outputted firstly, wherein the first prompt message is configured to prompt a performing operation corresponding to the voice instruction to the user, and may assist the user to judge whether the voice instruction is correct. If an operation on the first control is detected within a first predetermined time, then the voice instruction is cancelled and the voice instruction is not responded to. If an operation on the first control is not detected within the first predetermined time, then the voice instruction is responded to. According to some embodiments of the present disclosure, the voice instruction may be cancelled before being responded to, so as to terminate a corresponding performing operation in response to the voice instruction, rather than to terminate the performing operation after the performing operation is performed, so that the operation cost can be reduced, and the operation efficiency can be improved.

The technical solutions of the present disclosure will be described in details hereinafter with reference to the drawings.

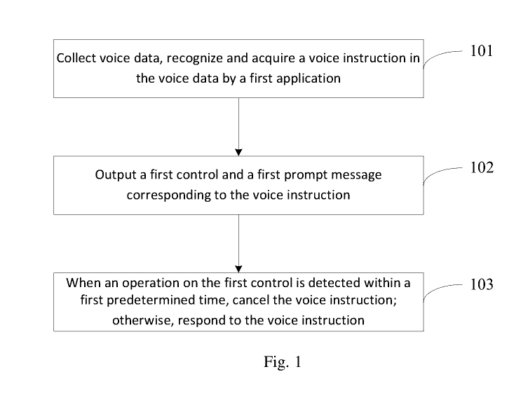

FIG. 1 is a flow chart of one embodiment of a method for processing voice messages provided by some embodiments of the present disclosure. The method may include the several steps as follows.

In step 101: a first application collects voice data, recognizes and acquires a voice instruction in the voice data.

The first application refers to an application like a voice assistant which is installed in an electronic apparatus, and implements the operation on the electronic apparatus through voice interaction so as to substitute partial operations of a user.

The voice instruction may be composed of key words in the voice data, for example, the voice instruction may be “call XX”, “open the camera”, “send short message to XX”, “open the music player”, “tell jokes”, “what's the weather like today”, “train schedule from Beijing to Nanjing”, “how to go to Tian An Men”, etc.

The voice data may be recorded by the user through triggering the first application.

The first application may provide a voice instruction prompt message to the user, so that the user can record accurate voice data, which is convenient for the first application to recognize.

In step 102: a first control and a first prompt message corresponding to the voice instruction are outputted.

Wherein, the first prompt message is configured to prompt a performing operation corresponding to the voice instruction to a user.

After the voice instruction is recognized, the first prompt message and the first control are outputted firstly and displayed in a display interface of the first application in some embodiments of the present disclosure.

The first prompt message may be a text message, wherein one manner may be to convert the voice instruction into text contents as the first prompt message, or the first prompt message is generated according to the text contents, for example, a voice instruction is “call XX”, then a text message “call XX”, or “call XX in process”, or “call XX in 3 s” may be outputted.

In step 103: when an operation on the first control is detected within a first predetermined time, the voice instruction is cancelled; otherwise, the voice instruction is responded to.

Through the operation on the first control, the current voice instruction may be cancelled, and there is no need to respond to the voice instruction.

If the operation on the first control is detected within the first predetermined time, then the voice instruction is cancelled; while if the operation on the first control is not detected within the first predetermined time, then a corresponding performing operation is performed in response to the voice instruction.

The first predetermined time may be started from the moment of outputting the first prompt message and the first control.

Within the first predetermined time, the user may judge the current voice instruction according to the first prompt message; if the voice instruction is incorrect, then the voice instruction may be cancelled through operating the first control; while if the voice instruction is correct, then the voice instruction may be responded to after the first predetermined time.

Some embodiments of the present disclosure may facilitate the user to judge whether the voice instruction is correct through the first predetermined time and the first prompt message, and the user may cancel the voice instruction through the first control when the voice instruction is wrong, thus avoiding subsequent operations caused by the wrong voice instruction, so that the operation cost is reduced, and the user may correct the wrong voice instruction in time, so that the operation efficiency may be improved.

The first control may be a virtual control outputted in the display interface. The operation of the user on the first control may specifically be a touch operation, and the voice instruction may be cancelled through the touch operation on the first control.

To facilitate the user to recognize the first control, an operation prompt message such as a text message “cancel” may also be outputted in the first control.

After cancelling the responding instruction, a cancellation prompt message may also be outputted, for instance, when the voice instruction is “call XX”, the cancellation prompt message the call is cancelled” may be outputted after cancelling the responding instruction.

Because the performing operation corresponding to the voice instruction may be possibly performed by the first application only, for example, in such an application scenario of implementing intelligent conversation, the voice instruction may be responded to immediately even if the voice instruction is wrong, which may also increase the interesting of the intelligent conversation.

While if a second application needs to be invoked to respond to the voice instruction, then the second application needs to be operated, and the second application needs to be switched to so as to perform the voice instruction; if the voice instruction is wrong at this moment, the operation cost is thus increased.

Therefore, as another embodiment, after the voice instruction in the voice data is recognized and acquired, the performing operation corresponding to the voice instruction may be judged whether to be performed by invoking the second application; if yes, then the first control and the first prompt message corresponding to the voice instruction are outputted; and if not, the voice instruction may be responded to directly.

Wherein, the second application is any application different from the first application.

For example, a voice instruction is “call XX”, which needs to invoke a dialing program to perform a dialing operation, then the second application is namely a dialing program; a voice instruction is “open the camera” which needs to invoke a camera application to perform a photographing operation, then the second application is a camera application.

Wherein, the second application needs to be invoked for performing may specifically refer to that it needs to enable the second application and switch to the second application for performing For example, a voice instruction is “call XX”, a dialing program needs to be enabled, and a dialing program display interface needs to be displayed.

After the first application is enabled, a display interface of the first application may be outputted, wherein the display interface of the first application may include a voice recording control, and the user may record voice through operating the voice recording control; therefore, collecting the voice data by the first application may specifically to collect the voice data when an operation on the voice recording control is detected.

The first prompt message and the first control may specifically be displayed in the display interface of the first application. If the second application needs to be invoked for performing the performing operation corresponding to the voice instruction, responding to the voice instruction is specifically to invoke the second application to perform the performing operation corresponding to the voice instruction and output a display interface of the second application at the same time. Because the second application needs to be invoked for performing; once the voice instruction is wrong, the voice instruction may be cancelled before the second application is invoked, thus not needing to invoke the second application, so that the operation cost is reduced, and the operation efficiency is improved.

To facilitate distinguishing, the first prompt message may be specifically outputted in a first display area of the display interface of the first application, and the first control may be outputted in a second display area. Wherein, the background colors of the first display area and the second display area may be different, and the sizes of the first display area and the second display area may also be different.

As another embodiment, in order to prompt the first predetermined time to the user, a second prompt message may also be outputted while outputting the first control and the first prompt message corresponding to the voice instruction.

The second prompt message is configured to dynamically prompt a time difference from the current moment to the first predetermined time to the user, and the maximum time difference is the first predetermined time.

That is, the second prompt message is a dynamic timing message, and more particularly, to a dynamic countdown message.

Certainly, the second prompt message may also be a time difference from the moment of outputting the second prompt message to the current moment, i.e., is a dynamic count-up message, and the maximum time difference is the first predetermined time.

The response moment of responding to the instruction may be prompted to the user through the second prompt message, thus facilitating the user to judge and determine whether to operate the first control in time.

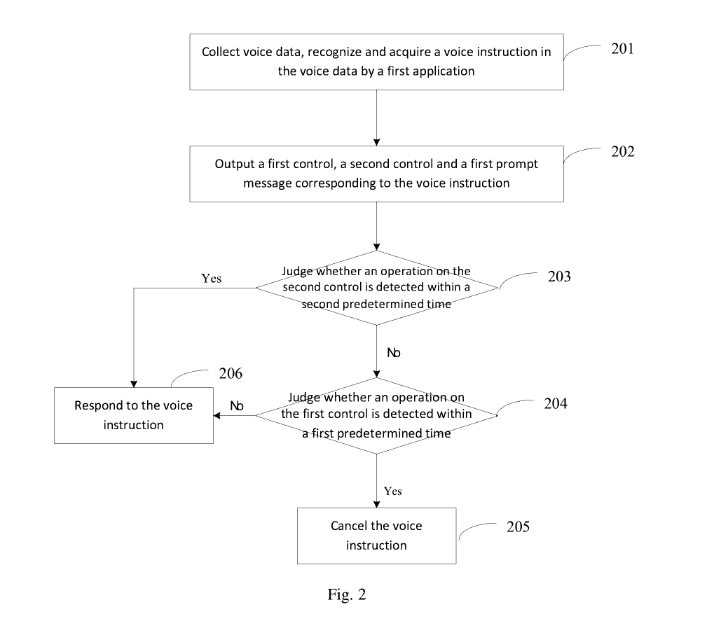

FIG. 2 is a flow chart of one embodiment of another method for processing voice messages provided by some embodiments of the present disclosure. The method may include the several steps as follows.

In step 201: a first application collects voice data, recognizes and acquires a voice instruction in the voice data.

In step 202: a first control, a second control and a first prompt message corresponding to the voice instruction are outputted.

In some embodiments, the second control is also outputted while outputting the first prompt message and the first control.

Certainly, a second prompt message may also be outputted.

In step 203: an operation on the second control is judged whether to be detected within a second predetermined time; if yes, then step 206 is performed; and if not, then step 204 is performed.

In step 204: an operation on the first control is judged whether to be detected within a first predetermined time; if yes, then step 205 is performed; and if not, then step 206 is performed.

Wherein, the second predetermined time is less than or equal to the first predetermined time.

In step 205: the voice instruction is cancelled.

In step 206: the voice instruction is responded to.

Through the setting of the second control, the voice instruction may be responded to immediately if the operation on the second control is detected within the second predetermined time. Otherwise, it needs to wait for the first predetermined time, and the voice instruction is responded to when the operation on the first control is not detected within the first predetermined time.

To facilitate the user to recognize the first control and the second control, a first operation prompt message such as a text message “cancel” may also be outputted in the first control, and a second operation prompt message such as “confirm” may be outputted in the second control.

In some embodiments, the user may judge whether the current voice instruction is correct through the first prompt message; if the current voice instruction is correct, then the voice instruction may be responded to immediately through operating the second control; and if the current voice instruction is wrong, then the voice instruction may be cancelled immediately and not responded to through operating the first control. Through some embodiments, the operation cost is reduced, wrong operations are avoided, and the operation efficiency is improved; moreover, the correct voice instruction may be responded to immediately through the second control, so that the operation efficiency is further improved.

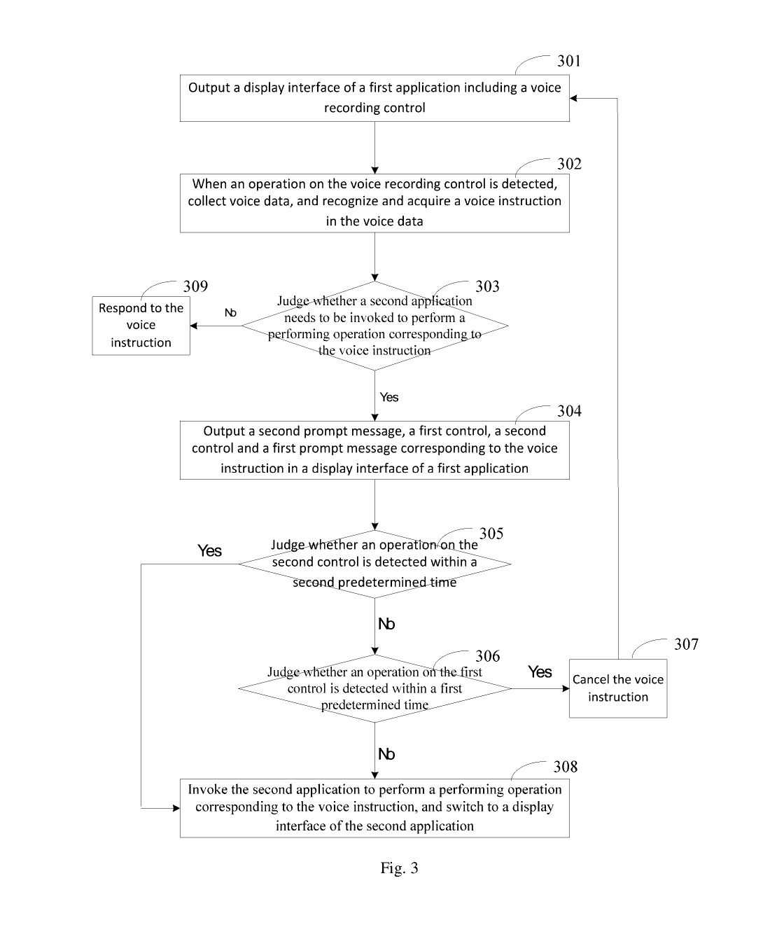

FIG. 3 is a flow chart of another embodiment of the method for processing voice messages provided by some embodiments of the present disclosure. The method may include the several steps as follows.

In step 301: a display interface of a first application including a voice recording control is outputted.

In step 302: when an operation on the voice recording control is detected, voice data is collected, and a voice instruction in the voice data is recognized and acquired.

In step 303: it is judged that whether it needs to invoke a second application to perform a performing operation corresponding to the voice instruction; if yes, then step 304 is performed; and if not, then step 309 is performed.

Wherein, the second application is any application different from the first application.

In one practical application, the second application may specifically be a dialing program configured to initiate a communication connection.

In step 304: the second prompt message, the first control, the second control and the first prompt message corresponding to the voice instruction are outputted in the display interface of the first application.

The first prompt message is configured to prompt a performing operation corresponding to the voice instruction to a user.

The second prompt message is configured to prompt a time difference from the current moment to the first predetermined time to a user.

In step 305: an operation on the second control is judged whether to be detected within a second predetermined time; if yes, then step 308 is performed; and if not, then step 306 is performed.

In step 306: an operation on the first control is judged whether to be detected within a first predetermined time; if yes, then step 307 is performed; and if not, then step 308 is performed.

In step 307: the voice instruction is cancelled, and step 301 is returned.

In step 308: the second application is invoked to perform the performing operation corresponding to the voice instruction, and a display interface of the second application is switched to.

In step 309: the voice instruction is responded to.

Wherein, the outputting the first prompt message, the second prompt message, the first control and the second control corresponding to the voice instruction in the display interface of the first application may particularly be as follows: the first prompt message may be displayed in a first display area, while the first control and the second control may be displayed in a second display area; the second prompt message may also be displayed in the second display area; or, as a probable implementation manner, the second prompt message may be specifically displayed in the first control or the second control.

The voice recording control may be continuously outputted, and may specifically be displayed at the junction of the first display area and the second display area.

To facilitate distinguishing, the first display area and the second display area may be distinguished by different background colors; the sizes of the first display area and the second display area may also be different, and may also be changed according to different moments corresponding to a dynamic timing message in the second prompt message.

In addition, step 301, i.e., outputting the display interface of the first application, may be returned after cancelling the responding instruction, and the voice data may be continuously collected.

While in the prior art, if the voice instruction is wrong, the second application can be triggered to end the performing operation corresponding to the voice instruction only after the second application is switched to; while after the performing operation is ended, it will stay in the second application continuously, or terminate the second application. Meanwhile, the first application will also be terminated, and the user can only re-start the first application to collect voice data until a correct voice instruction is acquired. While through some embodiments of the present disclosure, the display module may still stay in the first application to continuously display the display interface of the first application including the voice recording control after cancelling the responding instruction, and the user does not need to re-restart the first application, so that the operation cost is further reduced, and the operation efficiency is improved.

The technical solutions of some embodiments of the present disclosure will be described in details hereinafter by taking a voice instruction “call XXX” as an example and supposing that the first application is a voice assistant.

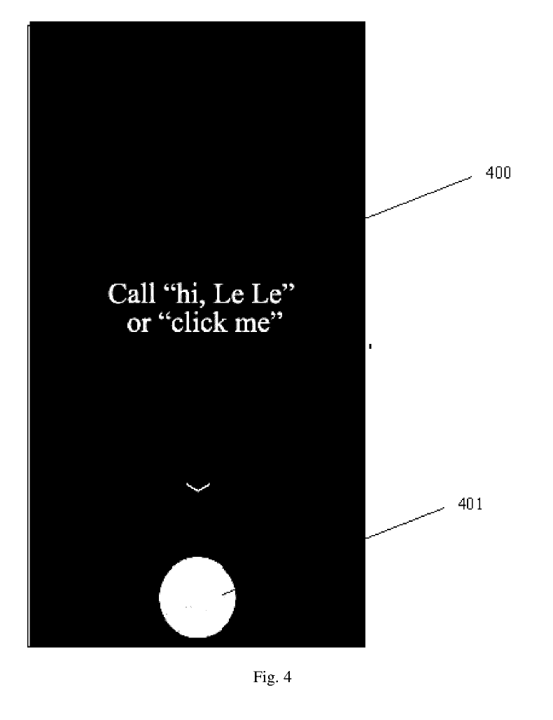

When the user starts the voice assistant, a display interface of the voice assistant is outputted, wherein the display interface of the voice assistant includes a voice recording control. As described in FIG. 4, the display interface 400 of the voice assistant includes the voice recording control 401.

A voice recording prompt message such as click me or call “hi, Le Le” in FIG. 4, may also be outputted in the display interface of the voice assistant, so that the voice assistant may be triggered to collect the voice data.

The user may trigger the voice assistant to start collecting the voice data through clicking the voice recording control 401 or through the voice data including preset key words like “hi, Le Le” in FIG. 4.

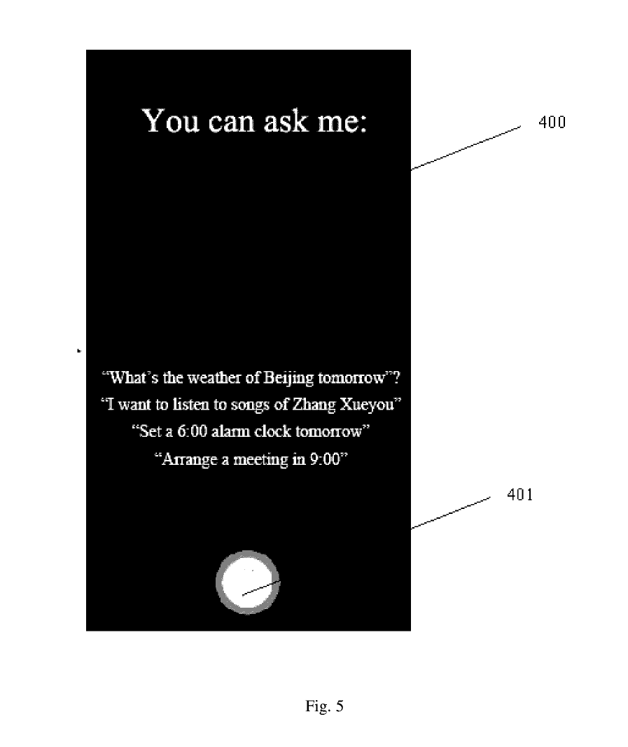

If the voice data is not collected within a certain time after the operation on the voice recording control is detected or the voice data including the preset key words is received, then a prompt message of the voice instruction may also be outputted so as to prompt the user to entry correct voice data, which is as shown in FIG. 5.

The voice recording control may at least include a state of recording in progress and a state of waiting for recording. The voice recording control in FIG. 4 is under a state of waiting for recording, and the voice recording control in FIG. 5 is under a state of recording in progress. Under the state of recording in progress, the voice assistant may collect the voice data. The voice recording control may be switched from the state of recording in progress to the state of waiting for recording when receiving a click operation of the user, or detecting the voice data including the preset key words, or the like.

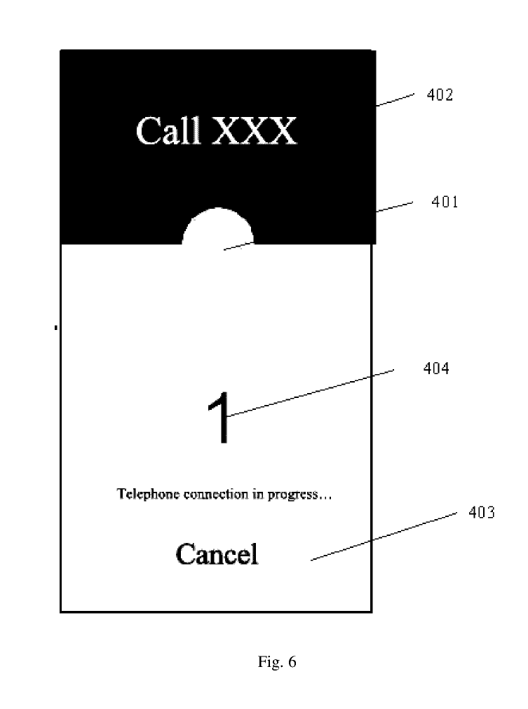

If the voice data is collected and the voice instruction “call XXX” is recognized, as shown in FIG. 6, a first prompt message 402 and a first control 403 corresponding to the voice instruction are outputted in the display interface of the voice assistant firstly. the first prompt message may include text contents, i.e., “call XXX”, converted from the voice instruction. A performing operation message corresponding to the voice instruction, such as “telephone connection in progress”, may also be outputted.

To facilitate the user to recognize the first control, a first operation prompt message such as a text message “cancel” in Fig.6 may also be outputted in the first control.

Meanwhile, a second prompt message 404 may also be outputted, wherein the second prompt message is a dynamic countdown message. Certainly, as another probable implementation manner, the second prompt message may also be outputted in the first control.

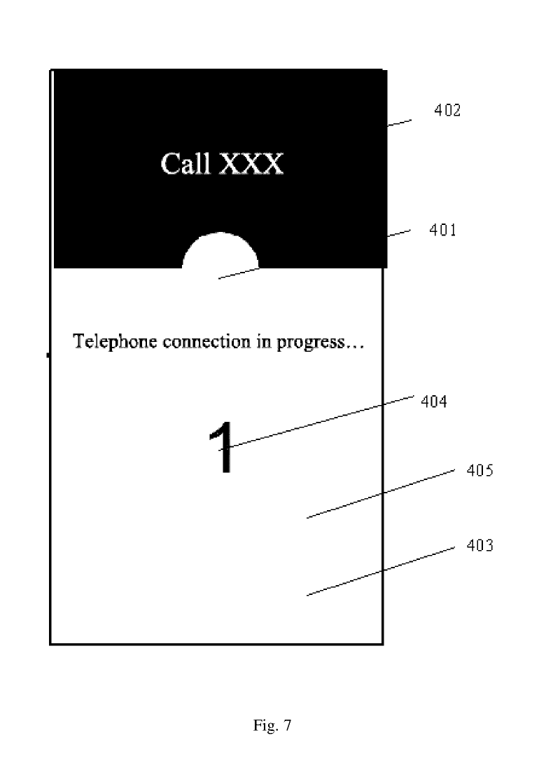

In addition, as shown in FIG. 7, a second control 405 may also be outputted in the display interface of the voice assistant. To facilitate the user to recognize the second control, a second operation prompt message such as a text message “confirm” in FIG. 7 may also be outputted in the second control.

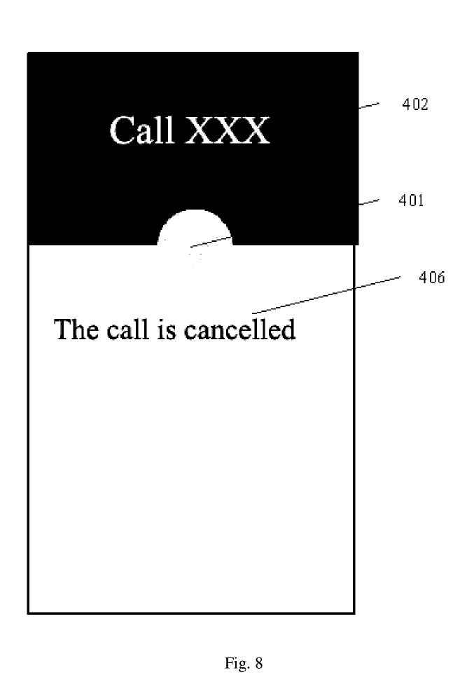

If the operation on the first control is detected within the first predetermined time which is supposed to be 3 s corresponding to the countdown, then the responding instruction is cancelled, and a cancellation prompt message like the cancellation prompt message the call is cancelled” in FIG. 8 may be outputted at the same time.

The display interface of the voice assistant is namely recovered to the display interface as shown in FIG. 4 after cancelling the responding instruction.

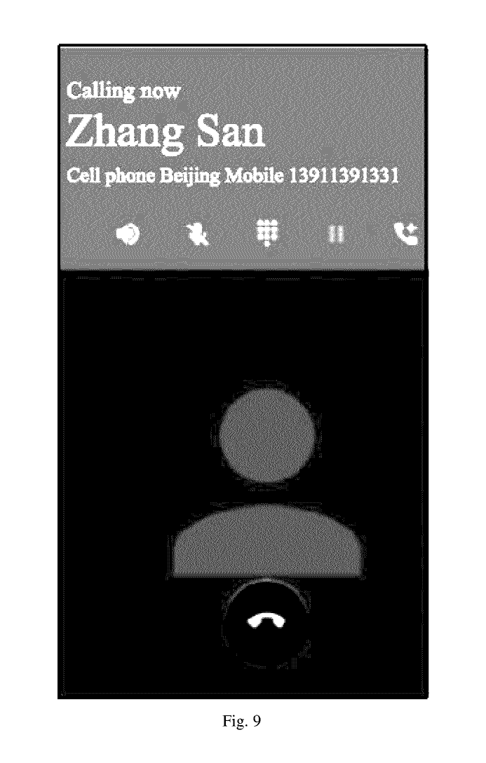

While if the operation on the first control is not detected within the first predetermined time, or the operation on the second control is detected within a second predetermined time, then a second application, i.e., a dialing program, may be invoked to initiate communication connection to “XXX”; meanwhile, a display interface of the dialing program is switched to; it is provided that XXX is Zhang San, as shown in FIG. 9 which is namely the display interface of the dialing program for performing the performing operation corresponding to the voice instruction, the voice assistant is terminated automatically when the performing operation of the dialing program is switched to.

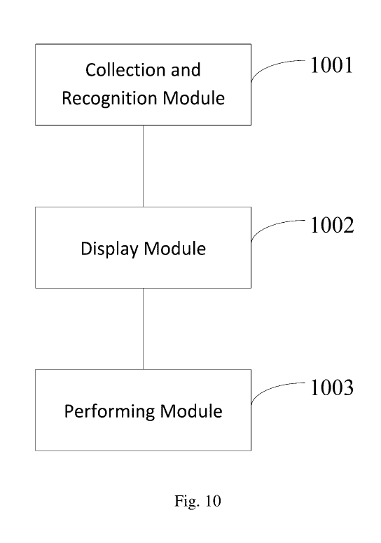

FIG. 10 is a structural schematic diagram of one embodiment of a device for processing voice messages provided by some embodiments of the present disclosure. The device may be applied to an electronic apparatus, may be integrated in a processor of the electronic apparatus as one function that can be implemented by the processor, and may also be served as an independent module connected to the processor. The device may include:

a collection and recognition module 1001 configured to collect voice data, recognize and acquire a voice instruction in the voice data;

a display module 1002 configured to output a first control and a first prompt message corresponding to the voice instruction, the first prompt message being configured to prompt a performing operation corresponding to the voice instruction to a user; and

a performing module 1003 configured to, when an operation on the first control is detected within a first predetermined time, cancel the voice instruction; otherwise, respond to the voice instruction.

The embodiment of the present disclosure facilitates a user to judge whether the voice instruction is correct through the first predetermined time and the first prompt message, and the user may cancel the voice instruction through the first control when the voice instruction is wrong, thus avoiding subsequent operations caused by the wrong voice instruction, so that the operation cost is reduced, and the user may correct the wrong voice instruction in time, so that the operation efficiency may be improved.

After cancelling the responding instruction, the display module may also output a cancellation prompt message, for instance, when the voice instruction is “call XX”, the cancellation prompt message “the call is cancelled” may be outputted after cancelling the responding instruction.

As another embodiment, the display module may be specifically configured to, when a second application needs to be invoked to perform the performing operation corresponding to the voice instruction, output the first control and the first prompt message corresponding to the voice instruction.

Wherein, the second application is any application different from the first application.

As another embodiment, in order to prompt the first predetermined time to the user, the display module, while outputting the first control and the first prompt message corresponding to the voice instruction, may also output a second prompt message.

The second prompt message is configured to dynamically prompt a time difference from the current moment to the first predetermined time to the user, and the maximum time difference is the first predetermined time.

That is, the second prompt message is a dynamic timing message, and more particularly, to a dynamic countdown message.

As another embodiment, the display module, while outputting the first control and the first prompt message corresponding to the voice instruction, is also configured to output a second control corresponding to the voice instruction; and

the performing module is also configured to, when an operation on the second control is detected within a second predetermined time, respond to the voice instruction, wherein the second predetermined time is less than or equal to the first predetermined time.

Through the first prompt message, the user may judge whether the current voice instruction is correct; if the current voice instruction is correct, then the voice instruction may be responded to immediately through operating the second control; and if the current voice instruction is wrong, then the voice instruction may be cancelled and not responded to immediately through operating the first control. Through some embodiments, the operation cost is reduced, wrong operations are avoided, and the operation efficiency is improved; moreover, the correct voice instruction may be responded to immediately through the second control, so that the operation efficiency is further improved.

As another embodiment, the display module is also configured to output a display interface of the first application including a voice recording control;

the collection and recognition module may be specifically configured to, when an operation on the voice recording control is detected, collect the voice data, recognize and acquire the voice instruction in the voice data; and

the performing module is also configured to trigger the display module to output the display interface of the first application including the voice recording control after cancelling the responding instruction.

Through some embodiments of the present disclosure, it may still stay in the first application to continuously display the display interface of the first application including the voice recording control after cancelling the responding instruction, and the user does not need to re-start the first application, so that the operation cost is further reduced, and the operation efficiency is improved.

Wherein, the display module may specifically output the first prompt message in a first display area of the display interface of the first application, and output the first control in a second display area, wherein the background colors and/or sizes of the first display area and the second display area are different.

The second control and the second prompt message may also be displayed in the second display area; or, as a probable implementation manner, the second prompt message may be specifically displayed in the first control or the second control.

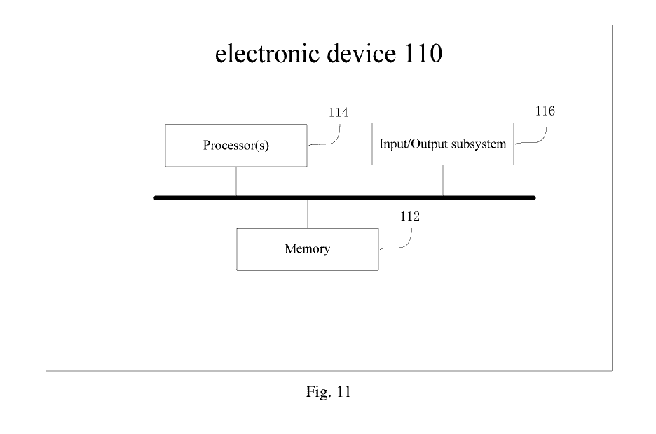

Attention is now directed toward embodiments of an electronic device. FIG. 11 is a block diagram illustrating an electronic device 110. The electronic device may include memory 112 (which may include one or more computer readable storage mediums), at least one processor 114, and input/output subsystem 116. These components may communicate over one or more communication buses or signal lines. It should be appreciated that the electrical device 110 may have more or fewer components than shown, may combine two or more components, or may have a different configuration or arrangement of the components. The various components may be implemented in hardware, software, or a combination of both hardware and software.

The at least one processor 114 may be configured to execute software (e.g. a program of one or more instructions) stored in the memory 112. For example, the at least one processor 114 may be configured to operate in accordance with the method of FIG. 1, the method of FIG. 2, the method of FIG. 3, or a combination thereof. To illustrate, the at least one processor 114 may be configured to execute the instructions that cause the at least one processor to:

collect voice data, recognize and acquire a voice instruction in the voice data;

output a first control and a first prompt message corresponding to the voice instruction, the first prompt message being configured to prompt an performing operation corresponding to the voice instruction to a user; and

when an operation on the first control is detected within a first predetermined time, cancel the voice instruction; otherwise, respond to the voice instruction.

As another example, the output the first control and the first prompt message corresponding to the voice instruction includes:

when a second application needs to be invoked to perform a performing operation corresponding to the voice instruction, output the first control and the first prompt message corresponding to the voice instruction, the second application being any application different from a first application.

As another example, the at least one processor, while outputting the first control and the first prompt message corresponding to the voice instruction, is also caused to output a second prompt message corresponding to the voice instruction, the second prompt message being configured to prompt a time difference from the current moment to the first predetermined time to the user.

As another example, the at least one processor, while outputting the first control and the first prompt message corresponding to the voice instruction, is also caused to output a second control corresponding to the voice instruction; and

the at least one processor is also caused to, when an operation on the second control is detected within a second predetermined time, respond to the voice instruction, wherein the second predetermined time is less than or equal to the first predetermined time.

As another example, the at least one processor is also caused to output a display interface of the first application including a voice recording control;

the collect the voice data, recognize and acquire the voice instruction in the voice data includes: when an operation on the voice recording control is detected, collect the voice data, recognize and acquire the voice instruction in the voice data; and

the at least one processor is also caused to output the display interface of the first application including the voice recording control after cancelling the voice instruction.

As another example, the output the first control and the first prompt message corresponding to the voice instruction includes:

output the first prompt message in a first display area of the display interface of the first application, and output the first control in the second display area, wherein the background colors and/or sizes of the first display area and the second display area are different.

The electronic device in some embodiments of the present application is practiced in various forms, including, but not limited to:

(1) a mobile communication device: which has the mobile communication function and is intended to provide mainly voice and data communications; such terminals include: a smart phone (for example, an iPhone), a multimedia mobile phone, a functional mobile phone, a low-end mobile phone and the like;

(2) an ultra mobile personal computer device: which pertains to the category of personal computers and has the computing and processing functions, and additionally has the mobile Internet access feature; such terminals include: a PDA, an MID, an UMPC device and the like, for example, an iPad;

(3) a portable entertainment device: which displays and plays multimedia content; such devices include: an audio or video player (for example, an iPod), a palm game machine, an electronic book, and a smart toy, and a portable vehicle-mounted navigation device;

(4) a server: which provides services for computers, and includes a processor, a hard disk, a memory, a system bus and the like; the server is similar to the general computer in terms of architecture; however, since more reliable services need to be provided, higher requirements are imposed on the processing capability, stability, reliability, security, extensibility, manageability and the like of the device; and

(5) another electronic device having the data interaction function.

The device embodiments described above are only exemplary, wherein the units illustrated as separation parts may either be or not physically separated, and the parts displayed by units may either be or not physical units, i.e., the parts may either be located in the same place, or be distributed on a plurality of network units. A part or all of the modules may be selected according to an actual requirement to achieve the objectives of the solutions in some embodiments. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a diskette, an optical disk or the like, and includes several instructions for instructing a computer apparatus (which may be a personal computer, a server, or a network apparatus so on) to perform the method according to each embodiment or some parts of some embodiments.

It should be finally noted that the above embodiments are only configured to explain the technical solutions of the present disclosure, but are not intended to limit the present disclosure. Although the present disclosure has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the technical solutions of some embodiments of the present disclosure.

1. A method for processing voice messages, comprising:
at an electronic device:
collecting voice data, recognizing and acquiring a voice instruction in the voice data by a first application;
outputting a first control and a first prompt message corresponding to the voice instruction, the first prompt message being configured to prompt a performing operation corresponding to the voice instruction to a user; and
when an operation on the first control is detected within a first predetermined time, cancelling the voice instruction; otherwise, responding to the voice instruction.

2. The method according to claim 1, wherein the outputting the first control and the first prompt message corresponding to the voice instruction comprises:
when a second application needs to be invoked to perform a performing operation corresponding to the voice instruction, outputting the first control and the first prompt message corresponding to the voice instruction, the second application being any application different from the first application.

3. The method according to claim 1, wherein the method, while outputting the first control and the first prompt message corresponding to the voice instruction, further comprises:
outputting a second prompt message corresponding to the voice instruction, the second prompt message being configured to prompt a time difference from the current moment to the first predetermined time to the user.

4. The method according to claim 1, wherein the method, while outputting the first control and the first prompt message corresponding to the voice instruction, further comprises:
outputting a second control corresponding to the voice instruction; and
when an operation on the second control is detected within a second predetermined time, responding to the voice instruction, wherein the second predetermined time is less than or equal to the first predetermined time.

5. The method according to claim 1, wherein the collecting the voice data, recognizing and acquiring the voice instruction in the voice data by the first application comprises:
outputting a display interface of the first application comprising a voice recording control; and
when an operation on the voice recording control is detected, collecting the voice data, recognizing and acquiring the voice instruction in the voice data; and
the method, after the cancelling the voice instruction, further comprises:
returning to the step of outputting the display interface of the first application comprising the voice recording control to perform continuously.

6. The method according to claim 1, wherein the outputting the first control and the first prompt message corresponding to the voice instruction comprises:
outputting the first prompt message in a first display area of the display interface of the first application, and outputting the first control in a second display area, wherein the background colors and/or sizes of the first display area and the second display area are different.

7. An electronic device, comprising:
at least one processor; and
a memory communicably connected with the at least one processor for storing instructions executable by the at least one processor, wherein execution of the instructions by the at least one processor causes the at least one processor to:
collect voice data, recognize and acquire a voice instruction in the voice data;
output a first control and a first prompt message corresponding to the voice instruction, the first prompt message being configured to prompt an performing operation corresponding to the voice instruction to a user; and
when an operation on the first control is detected within a first predetermined time, cancel the voice instruction; otherwise, respond to the voice instruction.

8. The electronic device according to claim 7, wherein the output the first control and the first prompt message corresponding to the voice instruction comprises:
when a second application needs to be invoked to perform a performing operation corresponding to the voice instruction, output the first control and the first prompt message corresponding to the voice instruction, the second application being any application different from a first application.

9. The electronic device according to claim 7, wherein the at least one processor, while outputting the first control and the first prompt message corresponding to the voice instruction, is also caused to output a second prompt message corresponding to the voice instruction, the second prompt message being configured to prompt a time difference from the current moment to the first predetermined time to the user.

10. The electronic device according to claim 7, wherein the at least one processor, while outputting the first control and the first prompt message corresponding to the voice instruction, is also caused to output a second control corresponding to the voice instruction; and
the at least one processor is also caused to, when an operation on the second control is detected within a second predetermined time, respond to the voice instruction, wherein the second predetermined time is less than or equal to the first predetermined time.

11. The electronic device according to claim 7, wherein the at least one processor is also caused to output a display interface of the first application comprising a voice recording control;
the collect the voice data, recognize and acquire the voice instruction in the voice data comprises: when an operation on the voice recording control is detected, collect the voice data, recognize and acquire the voice instruction in the voice data; and
the at least one processor is also caused to output the display interface of the first application comprising the voice recording control after cancelling the voice instruction.

12. The electronic device according to claim 11, wherein the output the first control and the first prompt message corresponding to the voice instruction comprises:
output the first prompt message in a first display area of the display interface of the first application, and output the first control in the second display area, wherein the background colors and/or sizes of the first display area and the second display area are different.

13. A non-transitory computer-readable storage medium storing executable instructions that, when executed by an electronic device with a touch-sensitive display, cause the electronic device to:
collect voice data, recognize and acquire a voice instruction in the voice data;
output a first control and a first prompt message corresponding to the voice instruction, the first prompt message being configured to prompt an performing operation corresponding to the voice instruction to a user; and
when an operation on the first control is detected within a first predetermined time, cancel the voice instruction; otherwise, respond to the voice instruction.

14. The non-transitory computer-readable storage medium according to claim 13, wherein the output the first control and the first prompt message corresponding to the voice instruction comprises:
when a second application needs to be invoked to perform a performing operation corresponding to the voice instruction, output the first control and the first prompt message corresponding to the voice instruction, the second application being any application different from a first application.

15. The non-transitory computer-readable storage medium according to claim 13, wherein the electronic device, while outputting the first control and the first prompt message corresponding to the voice instruction, is also caused to output a second prompt message corresponding to the voice instruction, the second prompt message being configured to prompt a time difference from the current moment to the first predetermined time to the user.

16. The non-transitory computer-readable storage medium according to claim 13, wherein the electronic device, while outputting the first control and the first prompt message corresponding to the voice instruction, is also caused to output a second control corresponding to the voice instruction; and
the electronic device is also caused to, when an operation on the second control is detected within a second predetermined time, respond to the voice instruction, wherein the second predetermined time is less than or equal to the first predetermined time.

17. The non-transitory computer-readable storage medium according to claim 13, wherein the electronic device is also caused to output a display interface of the first application comprising a voice recording control;
the collect the voice data, recognize and acquire the voice instruction in the voice data comprises: when an operation on the voice recording control is detected, collect the voice data, recognize and acquire the voice instruction in the voice data; and
the electronic device is also caused to output the display interface of the first application comprising the voice recording control after cancelling the voice instruction.

18. The non-transitory computer-readable storage medium according to claim 13, wherein the output the first control and the first prompt message corresponding to the voice instruction comprises:
output the first prompt message in a first display area of the display interface of the first application, and output the first control in the second display area, wherein the background colors and/or sizes of the first display area and the second display area are different.
